(19) United States
(12) Patent Application Publication
(10) Pub. No.: US 2025/0124345 A1
(43) Pub. Date: Apr. 17, 2025

(54) SEPARATING TEMPERATURE AND TRAFFIC INFORMATION FROM COMPLEX DFOS DATA

(71) Applicant: NEC Laboratories America, Inc., Princeton, NJ (US)

(72) Inventors: Jian FANG, Princeton, NJ (US); Ting WANG, West Windsor, NJ (US); Junyi YE, Kearny, NJ (US)

(73) Assignee: NEC Laboratories America, Inc., Princeton, NJ (US)

(21) Appl. No.: 18/759,965

(22) Filed: Jun. 30, 2024

Related U.S. Application Data
(60) Provisional application No. 63/590,856, filed on Oct. 17, 2023.

(51) Int. Cl. G06N 20/00

(52) U.S. Cl. CPC G06N 20/00

(57) ABSTRACT

Disclosed are systems, methods, and structures that provide more accurate temperature measurements and/or derived measurements using distributed fiber optic sensing (DFOS) systems and methods. DFOS systems and methods according to aspects of the present disclosure employ distributed fiber optic sensing that determines real-time temperature changes and vehicle trajectories from two-dimensional (2D) DFOS data with very few labeled data. The 2D data is first divided into multiple grids and then pre-processed with image distortion methods to enrich diversity of temperature change patterns. The transformed grids are used to pre-train a masked autoencoder, which advantageously does not require labels. The encoder of the autoencoder learns intrinsic features of temperature and traffic patterns, which are later connected to an estimation network to solve downstream tasks trained on a small set of labeled data.

### CROSS-REFERENCE TO RELATED APPLICATIONS

This application claims the benefit of U.S. Provisional Patent Application Ser. No. 63/590,856 filed Oct. 17, 2023, the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to a high-precision, real-time, generalized framework providing accurate estimate of temperature changes and vehicle trajectory(ies) along roads that have deployed nearby DFOS system(s).

### BACKGROUND OF THE INVENTION

Distributed fiber optic sensing (DFOS) systems, methods, and structures-including distributed temperature sensing (DTS) have found widespread utility in contemporary industry and society. Given such utility and subsequent importance, improved techniques, structures, and methods that provide more accurate temperature measurements and/or derived measurements would represent a welcome addition to the art.

### SUMMARY OF THE INVENTION

An advance in the art is made according to aspects of the present disclosure that provides more accurate temperature measurements and/or derived measurements using distributed fiber optic sensing (DFOS) systems and methods.

In sharp contrast to the prior art, DFOS systems and methods according to aspects of the present disclosure employ distributed fiber optic sensing that determines real-time temperature changes and vehicle trajectories from two-dimensional (2D) DFOS data with very few labeled data. The 2D data is first divided into multiple grids and then pre-processed with image distortion methods to enrich diversity of temperature change patterns. The transformed grids are used to pre-train a masked autoencoder, which advantageously does not require labels. The encoder of the autoencoder learns intrinsic features of temperature and traffic patterns, which are later connected to an estimation network to solve downstream tasks trained on a small set of labeled data.

Viewed from multiple aspects, systems and methods according to aspect of the present disclosure detect both temperature changes and vehicle trajectories from 2D DFOS patterns. As compared to the classic time delay estimation (TDE) models, our inventive systems and methods perform one-step time delay estimation on 2D DFOS data, which avoids accumulated errors that plague multiple-step estimation.

As those skilled in the art will come to understand and appreciate, our inventive systems and methods according to aspects of the present disclosure are robust to noise, large estimation errors, and complex unexpected external factors such as strain, vibration, and missing data. Of further advantage, our data augmentation pipeline automatically generates input and output pairs for simulating complex temperature changes in real scenarios and our pre-training stage learns intrinsic properties from signal data itself using semi-supervised learning, while requiring very few labeled data.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagram showing illustrative data collection, data pre-processing, model pre-training, and temperature-traffic pattern recognition operations according to aspects of the present disclosure.

FIG. 3 is an illustrative Time vs Location plot showing temperature-traffic patterns from DFOS system and close-up/exploded region according to aspects of the present disclosure.

FIG. 4 is an illustrative portion of the Time vs Location plot of FIG. 3 showing illustrative complex patterns selected from DFOS data according to aspects of the present disclosure.

FIG. 5 is a series of examples showing automatically generated input-output pairs for simulating different temperature change patterns according to aspects of the present disclosure.

FIG. 6 is an illustrative flow chart of model pre-training according to aspects of the present disclosure.

FIG. 7 shows a series of illustrative image reconstruction examples from masked DFOS images at different training epochs (top) and a plot of training loss across time (bottom) according to aspects of the present disclosure

FIG. 8 is an illustrative flow chart of model estimation according to aspects of the present disclosure

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that distributed fiber optic sensing systems interconnect opto-electronic integrators to an optical fiber (or cable), converting the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and-depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

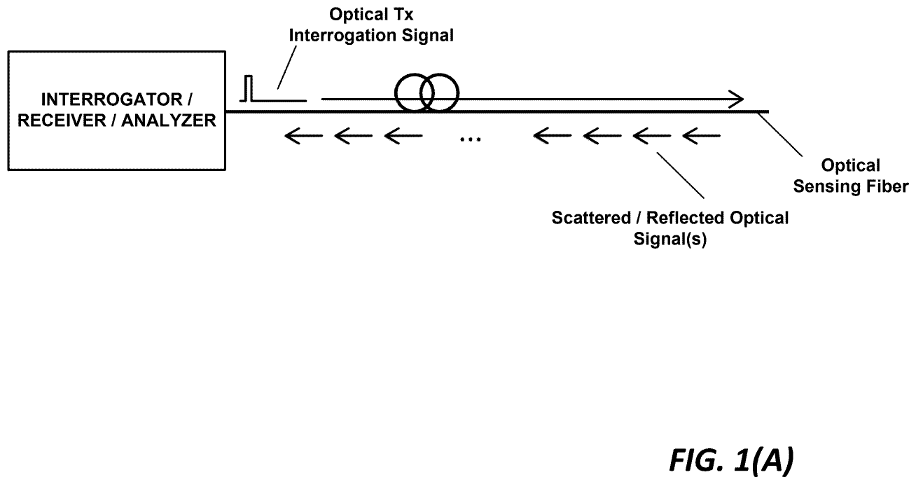

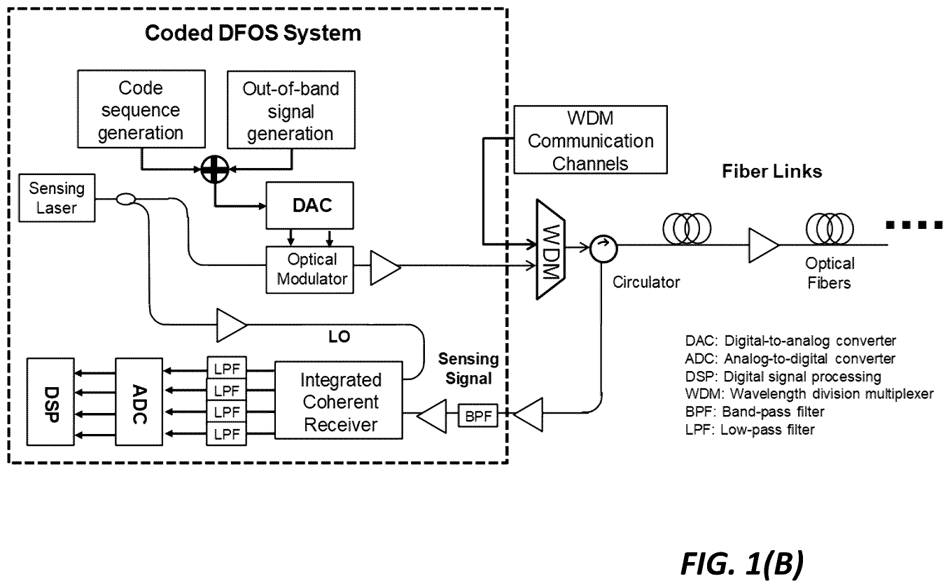

A schematic diagram illustrating the generalized arrangement and operation of a distributed fiber optic sensing system that may advantageously include artificial intelligence/machine learning (Al/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed temperature sensing (DTS) is a technology that uses fiber optic cables as linear temperature sensors. Unlike traditional point sensors, which measure temperature at discrete locations, DTS can provide a continuous temperature profile along the entire length of the cable. This makes it ideal for applications where it's important to monitor temperature changes over a large area or distance, such as:

Oil and gas pipelines: DTS can be used to detect leaks or blockages in pipelines by monitoring for changes in temperature.

Power cables: DTS can be used to monitor the temperature of power cables to prevent overheating and ensure efficient operation.

Buildings: DTS can be used to monitor the temperature of building walls, floors, and ceilings for energy efficiency purposes.

Geothermal applications: DTS can be used to monitor the temperature of wells and boreholes in geothermal energy applications.

As noted above, DTS operation is relatively straightforward.

A laser pulse is sent through the fiber optic sensor cable.

As the light pulse travels through the cable, it interacts with the molecules of the fiber optic material. This interaction causes some of the light to scatter back in the direction of the source.

The intensity and wavelength of the backscattered light are affected by the temperature of the fiber optic cable at the point where the scattering occurred.

By analyzing the intensity and wavelength of the backscattered light, the DTS system can determine the temperature at each point along the fiber optic cable.

DTS systems offer several advantages over traditional point sensors, including: High spatial resolution: DTS systems can measure temperature with a spatial resolution of less than a meter; Long distances: DTS systems can monitor temperature over long distances, up to several kilometers; Continuous monitoring: DTS systems provide a continuous temperature profile, which allows for better detection of trends and anomalies; and Durability: Fiber optic cables are resistant to harsh environments and can withstand high temperatures.

As noted, DFOS can employ different types of optical backscattering. The most common type is the Raman backscattering.

When an optical signal (such as a laser pulse) is sent into the fibers, the interaction between the incident light (photons) and the transmission medium (i.e. the optical sensor fiber) causes Raman scattering, which arises from differences in molecular vibration and rotation energy levels of the SiO₂ and GeO₂. This is an “inelastic” response therefore the wavelength of the Raman scattering is different from the incident light.

The Raman scattering light includes Stokes Raman scattering (atom or molecule absorbs energy, therefore scattered photo has less energy than the incident photon) and anti-Stokes Raman scattering (atom or molecule loses energy, therefore scattered photon has more energy than the incident photon).

Stokes and Anti-Stokes components have longer, and shorter wavelengths as compared to the incident light, respectively. Part of the Raman scattering light travels back to the source, therefore it is generally called the Raman backscattering.

Raman-based DTS measures the intensity of the two components of the Raman backscattering Pₛ and Pₐₛ at each location z, and calculate the temperature at the location T(z) using the following formula:

$$T ( z ) = \frac{γ}{ln \frac{{P}_{s} ( z )}{{P}_{a s} ( z )} + C - Δ α Z}$$

There are 3 coefficients in this equation, namely C, γ, and Δα. These 3 parameters need to be determined so that the temperature can be calculated. This determination is part of the system calibration process.

Ideally, three known temperature points are required to perform the calibration to obtain values for the three parameters. In practice, to eliminate noise in the measurement data, usually a continuous section of sensor fiber, such as a coil of sensor fiber, is used for each measurement point. Such coils of sensor fiber are sometimes referred as “temperature calibration zones”. We note that in this disclosure, “point” and “zone” are used interchangeably.

Two temperature baths can be located close to the sensor instrument, and a third one should be close to the end of the fiber cable. If the fiber type/characteristic is known and is the same throughout an entire route, two temperature zones would be sufficient for calibration.

In practical cases, if there is more than one section of fiber connected together (such as by splicing or using optical connectors), these parameters will be different from section to section, especially the parameter Δα. Therefore, calibration is required for each section of the sensor fiber.

In other words, two or three known temperature zones are required for each section, preferably including one located at the beginning and another one located at the end of the section. With temperature data determined at these corresponding locations, the 3 parameters for each section can be determined, and the temperature for all sections in the entire measurement/sensor fiber route can in turn be calculated from the measured Raman backscattering signal. Otherwise, if the calibration is only performed at the beginning section of the sensor fiber, the temperature values in the subsequent sections will be incorrect.

Besides Raman backscattering, there are also DTS systems based on Brillouin backscattering or Rayleigh backscattering. The physical principle and the procedures/equations to calculate temperature are different in these types of DTS sensors, however the calibration at each fiber section is also required. Therefore, temperature information at the beginning and end of each section is necessary for DTS operation in Raman/Rayleigh systems.

Known temperature data/information can be easily obtained using discrete temperature sensors/thermometers (such as thermal couplers, thermistors, etc.) These temperature sensors/thermometers are generally low cost, compact, technologically mature, and widely available commercially. However, one challenge with the use of such discrete sensors is how to transmit temperature information produced by the discrete sensors/thermometers from the field to the DTS sensor interrogator, which is oftentimes located at a central office (CO)—away from the measurement field.

Note that the external temperature information determination is a multi-step process. First, suitable locations for calibration are determined and thermometers or temperature sensors are positioned at those determined locations. The thermometers so located provide temperature measurement data to an acoustic modem transmitter which encodes the temperature measurement data as distributed vibration sensing or distributed acoustic sensing vibrations that are subsequently applied to an optical sensor fiber where they are conveyed back to a DVS/DAS system. The DAS/DVS system may be located at a central office and analyzes the DVS/DAS data to obtain temperatures as measured by the thermometers at the determined locations. The temperatures obtained are used to calibrate the overall DTS system.

As we have noted, DFOS is an effective and affordable technology that allows continuous, real-time measurements of optical signal data along the length of an optical sensor fiber. DFOS—and particularly Rayleigh backscattering based DFOS has a variety of applications in monitoring important physical variables, such as temperature, strain, vibration, etc. DFOS systems exhibit numerous desirable properties such as low attenuation, high transmission speed, immunity to electromagnetic noise, small size, light weight, flexibility, etc, that make it especially suitable for monitoring large infrastructures. For instance, deploying DFOS along roadways permits the capture of the patterns of temperature changes and vibrations caused by vehicle traffic.

In this disclosure we describe high-precision, real-time systems and methods that accurately estimate temperature changes and vehicle trajectories along roadways that have DFOS sensing fiber(s) deployed alongside.

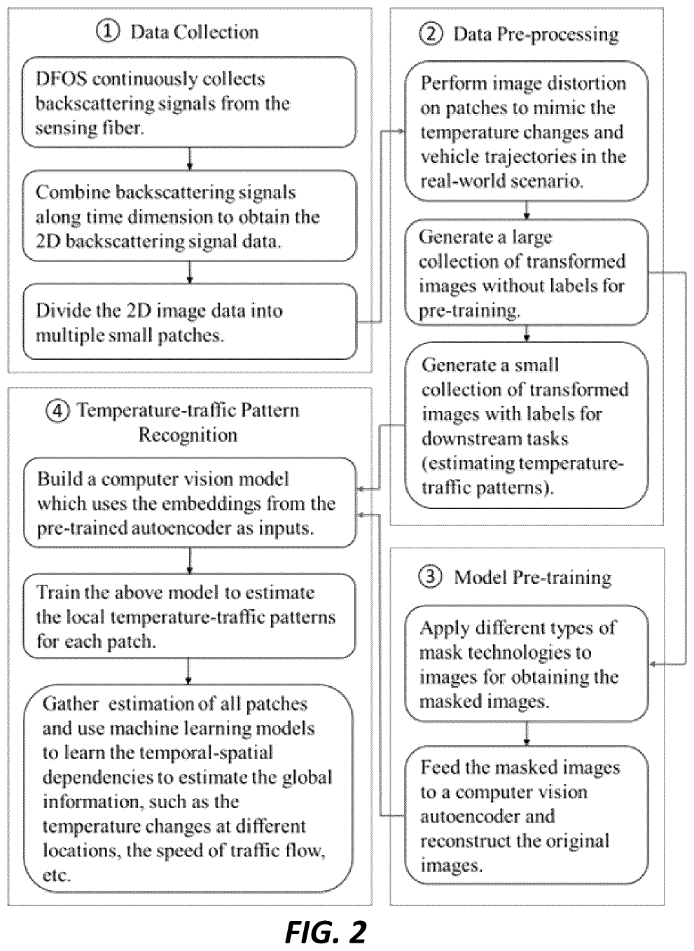

FIG. 2 is a schematic flow diagram showing illustrative data collection, data pre-processing, model pre-training, and temperature-traffic pattern recognition operations according to aspects of the present disclosure.

More specifically, our inventive systems and methods facilitate at least the following sub-tasks: for each time window, (1) estimate/determine absolute temperature change; (2) estimate/determine short-term temperature pattern, i.e., the relative temperature changes; (3) detect/determine positions and number of vehicles operating on/along a roadway; (4) recover any missing temperature patterns caused by operating vehicle vibrations; (5) determine/extract global temperature and traffic patterns, such as absolute temperature changes, traffic densities, and traffic speeds.

Currently, there do not exist generalized systems methods, and frameworks that can model the above complex problem for at least the following reasons. First, temperatures and traffic patterns from DFOS data are usually mixed, which significantly increases the difficulties of any sub-tasks. As a result, traditional methods such as Cross-Correlation and Hough transform for time delay estimation (TDE) and line detection can easily fail once a data pattern switches from one to another. Second, patterns derived from DFOS data is usually dynamic due to internal and external disturbances such as an unstable laser source, noise, strain, weather, and subsurface environmental conditions. For instance, vibrations attenuate at a greater rate in soft soil (soil with water) than in hard soil, or rock. Third, and finally, it is challenging to obtain a ground truth for DFOS data. For instance, it is often expensive, time-consuming, and sometimes infeasible to obtain high-resolution real-time temperature measurements along roadways. Therefore, any advantages of data-driven methods such as supervised deep learning, are limited.

We now describe our novel systems, methods, and generalized framework for estimating real-time temperature changes and vehicle trajectories from two-dimensional (2D) DFOS data with very few labeled data.

Operationally, 2D data is first divided into multiple grids and then transformed by pre-processing using image distortion techniques to enrich diversity of temperature change patterns. The transformed grids are used to pre-train a masked autoencoder, which advantageously does not require labels. An encoder of the masked autoencoder learns intrinsic features of temperature and traffic patterns, which are later connected to an estimation network to solve downstream tasks trained on a small set of labeled data.

As those skilled in the art will understand and appreciate upon consideration of our inventive disclosure: Our inventive systems, methods, and framework detect both temperature changes and vehicle trajectories from 2D DFOS patterns. When compared to “classic” TDE models, our inventive systems, methods, and framework perform one-step time delay estimation on 2D DFOS data, which advantageously avoids involving accumulated errors in multiple-step estimation.

Our inventive systems, methods, and framework are robust to noise, large estimation errors, and complex unexpected external factors such as strain, vibration, and missing data.

Additionally, our data augmentation pipeline automatically generates input and output pairs for simulating complex temperature changes in real scenarios. Our pre-training stage learns intrinsic properties from signal data itself using semi-supervised learning. Finaly, our inventive systems, method, and framework require very few labeled data.

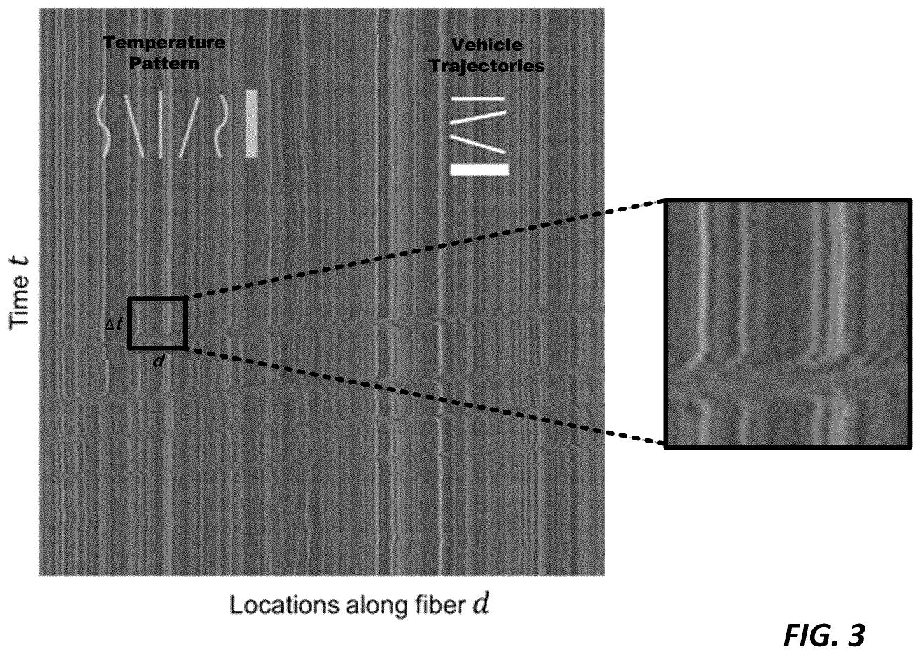

FIG. 3 is an illustrative Time vs Location plot showing temperature-traffic patterns from DFOS system and close-up/exploded region according to aspects of the present disclosure. With reference to that figure, it may be observed that it illustrates an illustrative case of DFOS data based on the backscattering mechanism that captures the temperature patterns and vehicle trajectories. The DFOS data is 2D where the x-axis, y-axis, and the color of pixels represent the temporal dimension, spatial dimension, and the intensity of the backscattering signal respectively. The DFOS system allows real-time measurements at thousands of points along a fiber optic cable, which provides 2D high-resolution feedback by the changes of important physical properties (such as temperature, strain, and vibration). Due to the dynamics of the external physical environment, the local DFOS patterns are changing over time and across space. To simplify the problem, we divide the DFOS data into small M×N grids.

In FIG. 3, we show a study case of one of the grids. The horizontal shift between any two adjacent signals (rows) reflects the relative temperature change in a single time interval. Overall, the shape (slope, curvature) of vertical line patterns describes the relative temperature changes during the period illustratively shown as Δt at region d. The temperature at any location in each region is assumed to be the same. The horizontal line pattern at the lower bottom part denotes the vehicle trajectories caused by vibration. Once the temperature (vertical) and traffic (horizontal) patterns for all the grids are extracted, we can estimate the overall temperature change and the density and average speed of the study road section at any period of time.

As those skilled in the art will further understand and appreciate, traditional TDE models such as Cross-Correlation (CC) and Generalized Cross-Correlation with Phase Transform (GCC-PHAT) are widely used to estimate the time delay or shift of two one-dimensional (1D) signals. However, they require data to be either noise-free or filtered noise. They also fail to handle those situations when strain or vibration is involved.

For instance, in the study area illustratively shown in the figure, a vehicle vibration generates a horizontal blurry pattern that covers the vertical temperature. On the other hand, temperature patterns are not always straight lines, which cannot be detected with traditional line detection algorithms such as Hough Transform. Sometimes, the vertical line structure will even split into two due to the impact of an unstable laser source or unexpected strains.

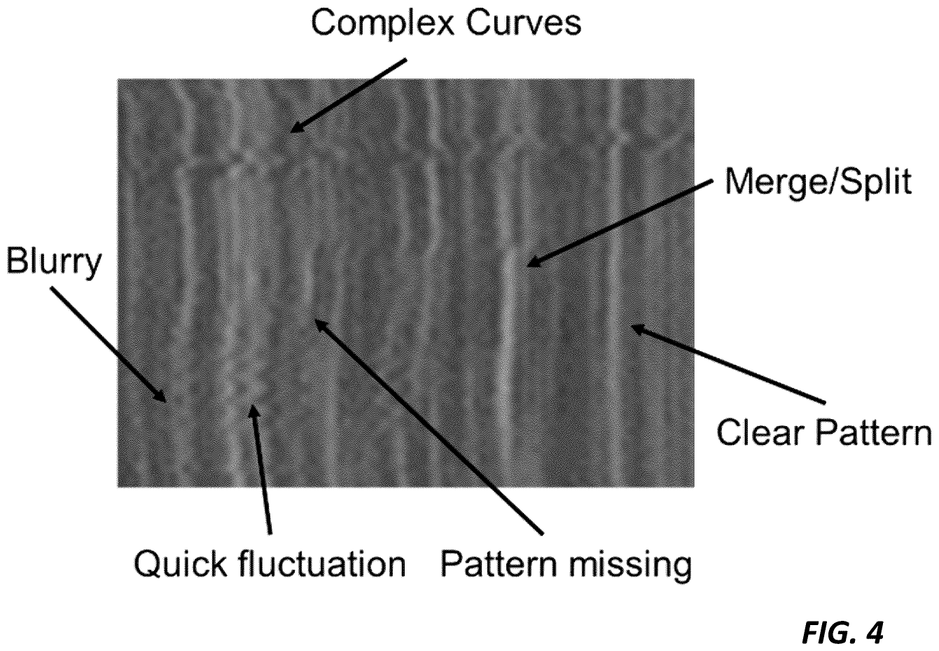

However, for humans, it is relatively easy to determine the relative changes of temperature even in the very complex environment of FIG. 4, which is an illustrative portion of the Time vs Location plot of FIG. 3 which shows illustrative complex patterns selected from DFOS data according to aspects of the present disclosure.

The inconsistency of local patterns such as blurry, fluctuation, pattern missing, pattern merging/splitting, and complex curve structures will not affect human's judgment that the overall temperature is stable in this time period by checking the continuous patterns on the right. Human vision can ignore the local failures or distortions and understand the essence of nature, i.e., the global pattern. This observation guides us that computer vision is a potential solution for this task since it is good at automatically recognizing both local and global spatial dynamics from images like humans.

Nevertheless, computer vision models require a large amount of labeled data. It is often challenging to obtain accurate labels for DFOS systems, such as the relative temperature changes in the study area. To solve this problem, this IR designs a novel data augmentation pipeline to automatically generate a collection of input (DFOS images) and labels (relative temperature changes) pairs that attempts to cover any arbitrary temperature patterns in the real scenario.

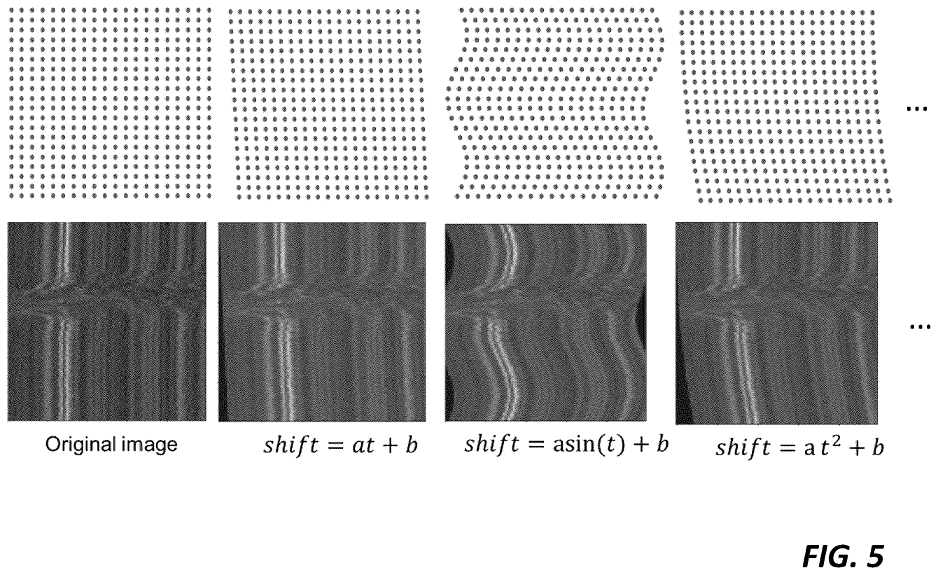

With simultaneous reference to FIG. 5 that is a series of examples showing automatically generated input-output pairs for simulating different temperature change patterns according to aspects of the present disclosure, our approach is as follows.

First, select a small set of grid images that have nearly straight vertical patterns, i.e., the vertical patterns are straight lines with some slope a. This can be easily determined with any line annotation tool that can draw a straight line on the image and compare the line with patterns from images. The slope can be calculated based on the coordinates of the start point and end point of the line. The relative shift over time for this image is represented with shift=at, where t is the temporal data along the y-axis.

Next, apply the Affine transform with different functions such as linear, sine/cosine, and quartic (but not limited to these) functions illustrated in FIG. 5 to mimic the complex dynamics of temperature.

Continuing, final relative shifts are calculated as shift′=shift+Affine(t)=at+Affine(t). In this inventive manner, we automatically generate diverse input and labels without sophisticated annotation. Note that the first step is only necessary for preparing labels for the relative temperature estimation task.

Recent studies suggest that pre-training computer vision models play an important role in a variety of image recognition tasks. Masked Autoencoder (MAE) is one of the simple but robust pre-training approaches. MAE is a class of deep learning models that trains an autoencoder on the masked input (images), which aims to restore the missing pixels in a semi-supervised manner. The embedding of the MAE extracts the high-level representation from data which shows significant improvement on any downstream tasks.

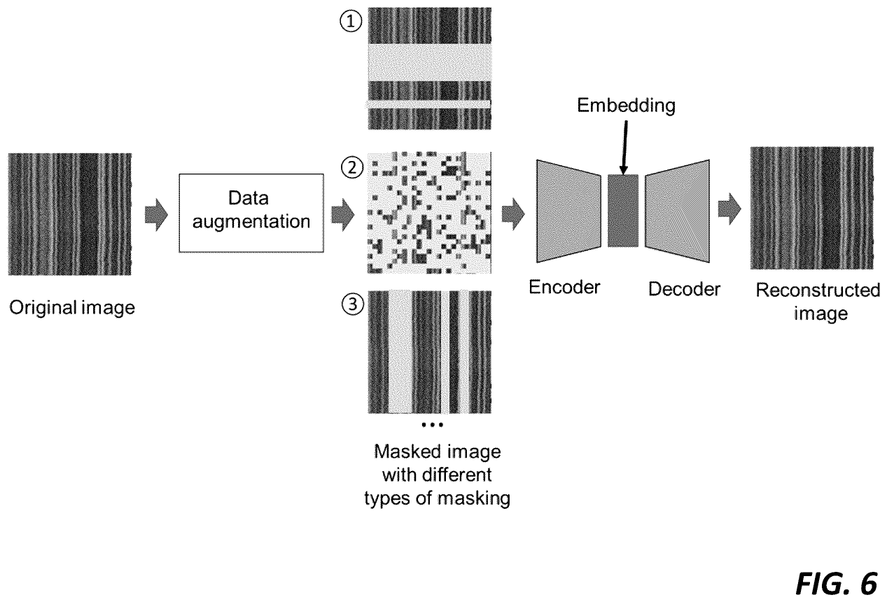

FIG. 6 is an illustrative flow chart of model pre-training according to aspects of the present disclosure. With reference to that figure, one may observe that grid data is preprocessed with Affine transform and image masking on the input image is performed with a randomly generated mask.

The middle portion of FIG. 6 illustrates three types of masking namely, horizontal masking, random masking, and vertical masking. Note however, that our inventive technique is not limited to these three illustrative masking types.

Continuing with our discussion of FIG. 6, a masked image is provided to an autoencoder to learn to reconstruct the original image. The embedding learned by MAE is a relatively low-dimensional feature vector that aims to capture the intrinsic patterns from DFOS data. Note that this pre-training approach is especially suitable for any downstream tasks for the DFOS system since DFOS usually can provide infinite unlabeled data.

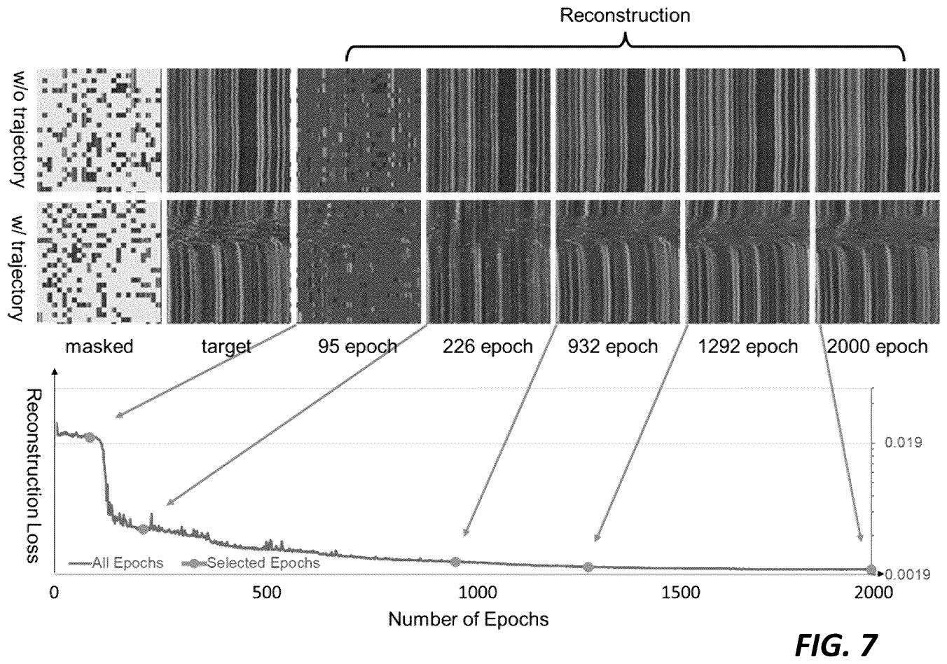

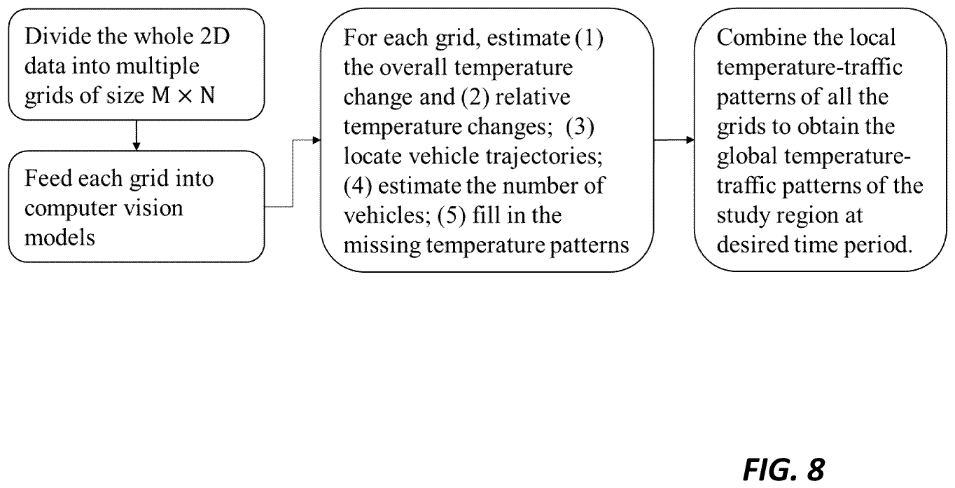

FIG. 7 shows a series of illustrative image reconstruction examples from masked DFOS images at different training epochs (top) and a plot of training loss across time (bottom) according to aspects of the present disclosure. With reference to that figure, we show that the masked autoencoder can accurately restore the missing pixels from the two masked images with a large masking rate of 75% after pre-training 2000 epochs on 50,000 unlabeled DFOS images. As those skilled in the art will understand and appreciate, the MAE can correctly restore both temperature and traffic trajectory patterns, which indicates that MAE is a crucial stage for deep learning models to understand DFOS data patterns.

After model pre-training, the encoder of MAE is combined with an estimator which is another deep learning model for training the downstream tasks shown in the middle block of FIG. 7. Note that estimating traffic-related tasks may require a small set of annotated samples such as the bounding boxes of vehicle trajectories. This can be simply obtained with any tools for bounding box annotation. To report the global temperature-traffic patterns, the framework combines the estimation result for every grid and then uses regression machine learning methods such as linear regression, neural networks, etc to capture both the spatial and temporal dependencies to give a high-precision and robust global estimation.

At this point, while we have presented this disclosure using some specific examples, those skilled in the art will recognize that our teachings are not so limited. Accordingly, this disclosure should be only limited by the scope of the claims attached hereto.

1. A distributed fiber optic sensing (DFOS)/distributed temperature sensing (DTS) operational method comprising:
operating a distributed fiber optic sensing (DFOS)/distributed temperature sensing (DTS) system to obtain two dimensional (2D) DFOS data;
transforming the 2D DFOS data into multiple grids and applying image distortion operations to the transformed grids;
training a masked autoencoder using the transformed grids such that the autoencoder learns intrinsic features of temperature and traffic patterns.

2. The method of claim 1 wherein the DFOS continuously collects backscattering signals from a DFOS optical sensing fiber disposed proximate to a roadway.

3. The method of claim 2 wherein the collected backscattering signals are combined along a time dimension to obtain the 2D DFPS data (backscattering signal data).

4. The method of claim 3 wherein the image distortion is performed on patches of the transformed grids such that actual/real-world temperature change(s) and vehicle trajectory(ies) are mimicked.

5. The method of claim 4 further comprising constructing a vision model using embeddings from the trained autoencoder as inputs.

6. The method of claim 5 further comprising training the constructed vision model to estimate local temperature-traffic patterns for each patch.

7. The method of claim 6 further comprising determining, from the estimated patches, temporal-spatial dependencies.

8. The method of claim 7 further comprising estimating, from the temporal-spatial dependencies, changes at different locations along the length of the optical sensor fiber.

9. The method of claim 8 wherein a change estimated from the temporal-spatial dependencies includes temperature changes.

10. The method of claim 8 wherein a change estimated from the temporal-spatial dependencies includes speed of traffic along the roadway.
